(19) United States
(12) Patent Application Publication
(10) Pub. No.: US 2010/0144451 A1
(43) Pub. Date: Jun. 10, 2010

(54) HIGH TORQUE DENSITY FLEXIBLE COMPOSITE DRIVESHAFT

(76) Inventor: Duncan J. Lawrie, Girard, PA (US)

Correspondence Address: ROETZEL & ANDRESS, 1375 EAST 9TH STREET, CLEVELAND, OH, 44114, US

(21) Appl. No.: 12/594,896

(22) PCT Filed: Apr. 7, 2008
(86) PCT No.: PCT/US08/59543

§ 371 Date: Dec. 29, 2009

Related U.S. Application Data
(60) Provisional application No. 60/921,953, filed on Apr. 6, 2007.

(51) Int. Cl. F16C 1/22; F16D 3/00

(52) U.S. Cl. 464/80

(57) ABSTRACT

An all-composite continuous filament wound flexible composite driveshaft with integral spacing tube and flexible diaphragms and methods of manufacture is disclosed. The flexible composite driveshaft obsoletes the split lines and associated fasteners required to attach metallic flex elements and either metallic or composite spacing tubes in current solutions. Sub-critical driveshaft weights half that of incumbent technology are projected for typical rotary wing shaft lengths. Fully anisotropic material properties are mapped to the deeply sculpted diaphragm geometry of flexible composite coupling elements, and a parametric numerical study of the complex shell disclosed. Continuous filament wound spacing tubes are described, which comprise an integral part of the initial tooling but which remain part of the finished shaft and control natural frequencies and torsional stability in conjunction with the flexible composite diaphragms.

### RELATED APPLICATION DATA

This application claims priority to U.S. provisional patent application No. 60/921,953 filed Apr. 6, 2007.

### FIELD OF THE INVENTION

This application is in the general field of materials, composite materials and material science engineering, and mechanical components made from engineered materials.

### BACKGROUND OF THE INVENTION

Flexible driveshafts for rotary wing power transmission are crucially important components for conventional helicopters at engine to gearbox, tail-rotor drive, and main mast locations. In the case of tilt-rotors the cross-over wing driveshafts rely extensively on the technology. Typically, titanium, aluminum or composite shafts are bolted through curvic face connectors to titanium diaphragm couplings to accommodate airframe distortions while transmitting the requisite power. These flexible drive trains emphasize minimum weight and hence demand torque density and small size. In the case of drive trains passing through flexing wing and fuselage structures the need for motion accommodation is also greater than for ground-based equipment—typically between 1.0 and 2.0 degrees per end. Power transmission coupling elements, which accommodate axial, bending, and transverse displacements, must do so while simultaneously carrying relatively large torsional large torsional loads. In short, it is difficult for a structural metallic membrane to simultaneously carry very large torsional shear and remain conveniently compliant to imposed out-of-axis distortions. Aircraft use, particularly rotary wing, more typically demands high angular motion to follow structural deformations. One expedient used to minimize weight is to operate at very high rotational speed such that torque is minimized for a given power. Limiting this high rpm is dynamic instability or classical ‘whirling’. Additional instabilities that affect the spacer shaft also include axial or “hunting” motions and torsional oscillations. Variables that drive this behavior are mass per unit length, axial, bending, and torsional stiffnesses—and boundary conditions. Clearly the primary objective for drive trains such as these is to allow bending rotations at each end, thus prescribing the boundary conditions. This, then, reduces the speed at which the fundamental bending or whirling speed is encountered.

State-of-the-art helicopter transmissions are operated below this critical speed in order to avoid the large lateral excursions that occur and the associated risk to the shaft plus adjacent wiring harnesses and hydraulic lines. A large literature exists concerning math modeling of this kind of dynamic behavior. However, axial force, large applied torques, shear forces and end moments all affect the prediction of natural frequencies. Much of the literature decouples the effects of some or all of the applied loading to reduce the complexity of the problem. For this reason natural frequencies are most often determined experimentally. Modern Composite materials add greatly to functionality and design freedom but anisotropic material properties further complicate the analyses.

### SUMMARY OF THE DISCLOSURE AND INVENTIONS

A representative diameter of the generally cylindrical driveshaft assembly and construct 10, as represented by the generally cylindrical spacing tube 200 is six inches. This driveshaft diameter is typical of tilt-rotor usage and larger conventional tail rotor drives. However, the inside diameter can range from approximately 2 inches to approximately 22 inches. A drive element with two bolted split lines can be made in accordance with the disclosure exactly as for the incumbent titanium designs. This approach used carbon and glass fiber derivatives filament wound into very short hyperbolic geometries such that the outside diameter exhibited fiber angles of approximately 45 degrees and the inside diameter angles were approximately 80 degrees. For this reason, the effective shell stiffness tangentially is higher than it is radially and more angular motion is therefore transferred. A further advantage is the geodesic winding path that facilitates manufacture but also eliminates all stresses other than fiber direction stresses, for thin membranes, when torque and motions are imposed. Limiting aspects include the thickness build-up where the fiber angle is steepest at the inside diameter. This detail requires that the diaphragms remain thin-walled and effectively limits the maximum torque that can be carried. Nevertheless, torque density and angular motion are comparable with metallic membranes.

Outstanding fatigue performance of the unidirectional composites used in the designs of the disclosure is achieved because all loading actions give rise to differential tension and compression in the fiber direction and shear stresses tend to zero when the wall thickness is small. Unlike metal diaphragms this is also projected to allow significant damage to be present without catastrophic consequences—hundreds of individual fiber bundles comprising the diaphragms behave exactly like a large number of redundant load paths.

Prior composite couplings and integrated driveshaft developments include braided solutions; elastomeric matrix composites; and numerous filament wound and pressed diaphragms, link packs, shim packs and similar. These designs provide attractive bending motion and reduced weight but give up torque density to the extent that they are not fielded solutions today. Most commonly, torque capacities consistently fell short of expectations because the fiber architecture always included local bending in the braid or wind. Also, the prescribed geometry typically required that the composite laminate be ‘pushed’ into shape before curing. The beam-column behavior of compression fibers in the first instance and developed shear stresses due to bending in the second conspired to give up nearly 90% of the achievable torque in every case. Elastomeric matrix composites have frequently been proposed as materials suitable for flexible driveshafts because of the obvious out-of-plane compliance possible. Unfortunately, the compression component of in-plane shear due to torque suffers from low micro-buckling strength and quite low torque density results. For a given fiber volume fraction in a composite shell the compression strength is linearly proportional to the shear modulus of the matrix resin. Suitable elastomeric resins provide shear modulii from 1-10% of that obtained using a typical epoxy. Further, all available elastomeric systems tend to produce limiting hysteretic heating effects under imposed bending motions.

### BRIEF DESCRIPTION OF THE FIGURES

In the accompanying Figures:

FIG. 1 illustrates an embodiment of a flexible composite driveshaft of the disclosure;

FIG. 2 sets forth closed loop performance test results on a 6-inch diameter flexible composite driveshafts of the disclosure;

FIG. 3 is angular deflection v. axial deflection; a plot of a representative coupling performance envelope;

FIGS. 4A-4C set forth plots of meridional stress with applied bending moment, hoop stress with applied bending moment, and in-plane shear stress with applied torque respectively for a flexible composite driveshaft of the disclosure;

FIGS. 5A-5C set forth plots of meridional stress with applied bending moment, hoop stress with applied bending moment, and in-plane shear stress with applied torque respectively for a flexible composite driveshaft of the disclosure;

FIGS. 6A-6B set forth plots of meridional stress with applied bending moment, hoop stress with applied bending moment respectively for a flexible composite driveshaft of the disclosure;

FIGS. 7A-7B set forth plots of meridional stress with applied bending moment, hoop stress with applied bending moment respectively for a flexible composite driveshaft of the disclosure;

FIG. 8 sets forth diaphragm bending stress for a family of 6 inch diameter hyperbolic coupling geometries of a flexible composite driveshaft of the disclosure subjected to ½ degree angular misalignment;

FIG. 9 sets forth torque imposed on a family of 6 inch diameter hyperbolic coupling geometries in response to ½ degree rotations about the shaft axis for flexible composite driveshafts of the disclosure, and

FIGS. 10A-10J set forth a survey of design parameters for flexible composite driveshafts of the disclosure.

### DETAILED DESCRIPTION OF PREFERRED AND ALTERNATE EMBODIMENTS OF THE DISCLOSURE

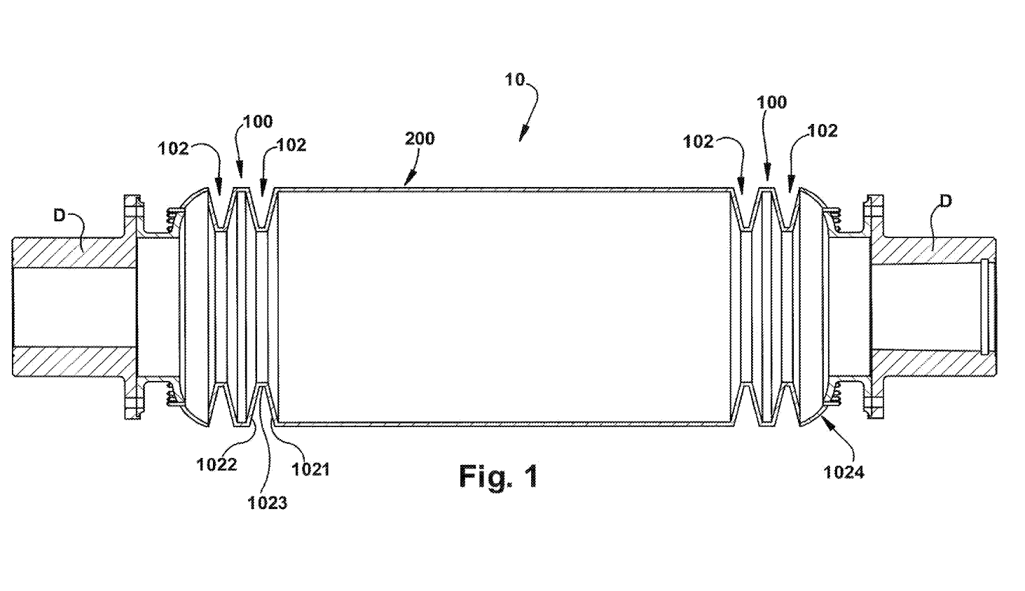

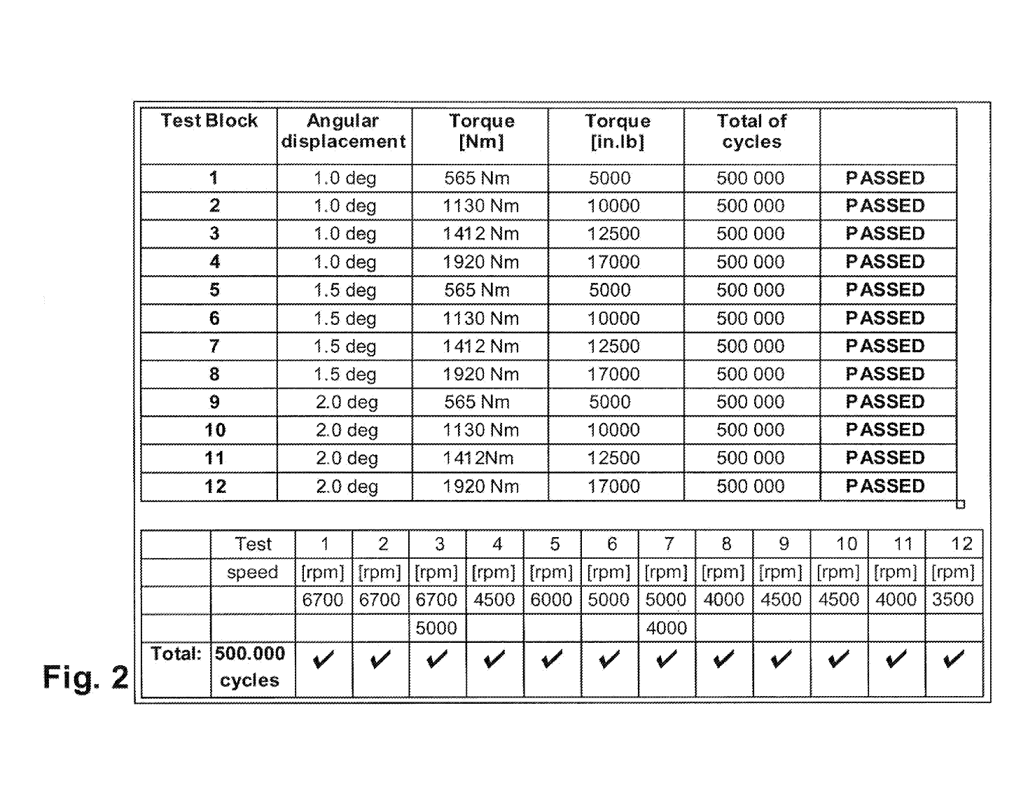

The present disclosure is of high torque density flexible composite driveshafts 10 which include flexible composite coupling elements 100 and integral spacing tube or tubes 200, as shown for example in FIG. 1. Each coupling element includes one or more diaphragms, generally indicated at 102. Each diaphragm 102 may have in a representative form a first angled wall 1021, a second angled wall 1022, and an intermediate inner diameter wall 1023. Each coupling element 102 further includes a shaft attachment 1024 which is structurally attached to a drive element D for mechanical power transmission by the flexible composite driveshaft 10.

The present disclosure has finessed both the design for performance and the manufacturing process using epoxy resins such that sustainable compression components of composite stress under pure torque are now approaching 170 ksi. This is achieved via a hands-off CNC controlled, repeatable process using traceable pre-impregnated materials and the approach also avoids bolted split lines and large fastener count. In the case of tilt rotor wing cross-over drives the weight savings may be as great as approximately 55%. Additionally, the avoidance of split line fasteners is designed to reduce windage losses and associated heat and noise generation substantially.

Continuing development of coupling elements (without spacing tubes) focused upon hyperbolic geometries offering acceptable torque and minimum shell bending stress without reducing thickness so much that torsional buckling of the diaphragm occurred before the in-plane strength was reached. With two degrees of bending per shaft end targeted a single hyperbolic flex element was required to provide a ½ degree per end. In no case was hysteretic heating experienced but it was clear that when thickness was increased above that required for 60,000 in.lb torque in a 6 inch diameter then ½ degree per diaphragm resulted in delamination over time. All comparison tests included axial and bending stiffness measurement, spin testing up to a ½ degree bending per diaphragm (1 degree per flex element) and 7,500 rpm followed by static torque to failure. Repeat axial stiffness tests were conducted after each increasing angular misalignment on a spin rig in an effort to pinpoint the onset of through-thickness shear failure.

The deeply sculpted diaphragms 102 of the coupling elements 100 are an integral part of a single continuously wound anisotropic shell created on a perfect geodesic path, in accordance with the design disclosure. The diaphragm regions are preferably comprised of constantly varying thickness and constantly varying material properties.

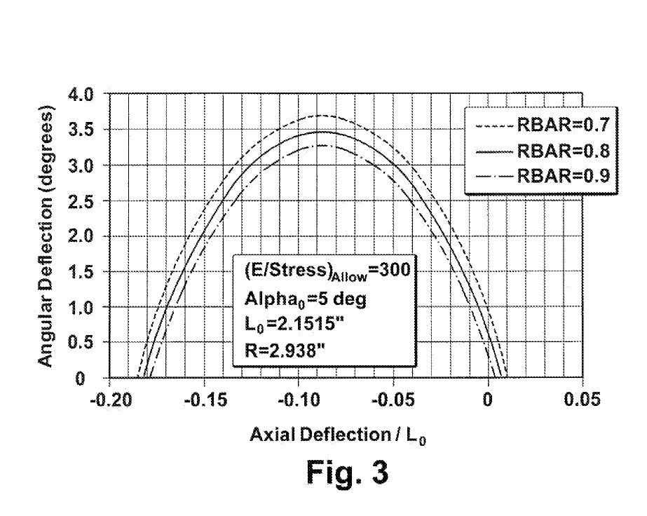

The expression provided in FIG. 3 includes strain components due to axial and bending imposed motions. The LHS of the expression provides for the residual strain available to carry torque assuming a material design allowable. This approach is accurate assuming no thickness effects, and any combination of imposed motion and torque consume the available design strain. The expression is also that of an ellipse and the non-dimensional elliptical design space is shown where alpha is the helix angle made by the fiber at the inside diameter to the diametral plane. Given that compressively loaded fibers fail before tensile fibers in the shell, and that only fiber direction tension and compression exists for small thickness (when wound on a perfect geodesic) then greater torque and higher bending is achievable when axial shortening is avoided and shafts are initially installed with small axial tension. The left upper quadrant of the elliptical design space depicted is considered to represent the strain space following snap-through buckling of the diaphragms. Because associated shock loading is undesirable in dynamic shaft applications this large additional design space is, regrettably, unavailable although the steadily reducing stiffness as snap-through is approached might be useful. Couplings with <10,000 in.lb torque to failure and small thickness were produced which exhibited this behavior and provided for >5 degree angular misalignment and >0.3 inch axial motion per diaphragm pair. When 20% more thickness was incorporated, the torque to failure increased by 150% and, indeed, the failure mode was demonstrably one of torsional buckling in the diaphragms. In fully integral or even assembled driveshafts at least one pair of diaphragms per end is required. Inevitably this means that one diaphragm will attract all the motion because of the unstable stiffness response.

In the FIG. 3 plot showing angular misalignment of the straight generation lines used to represent two hyperbolic fiber paths do not cross on the centerline—unlike that shown for axial displacement. It is useful to visualize a bundle of straws or pencils bound mid-length and then twisted about the axis to produce a hyperbola when viewed laterally. In the case of the composite flex element an open inside diameter exists such that the inside radius provides the torque arm necessary for each fiber bundle to contribute to power transmission.

In resolving fiber strains a family of trigonometric relations were developed and simply scaled by the number of fiber passes used to provide axial, bending and torsional stiffness values plus anticipated strength limits. It is not useful to reproduce these here. Steel and titanium flanges were analyzed via finite element modeling and the respective flange stiffnesses subtracted as springs in series from test results for the purpose of comparing composite performance with the analytical models. The lack of bending symmetry in FIG. 3 created concerns as to fidelity of motion in a misaligned, rotating, shaft thus constructed. In fact, very smooth operation was always observed and the precisely controlled manufacturing process even produced shafts that did not require subsequent balancing. In summary, the inability to closely match bending and axial stiffness predictions and the non-existence of lateral oscillations under imposed bending points toward diaphragm bending stress development not predicted by the analytical models. Torsional performance remains accurately predicted however.

S2-glass fiber is preferably used to carry torque with carbon fiber sandwiching in the spacing tube such that shaft stability, inertia, and natural frequencies can be optimized. The use of S2-glass fiber provides for three times the strain to failure of standard modulus carbon fiber without giving up load density. Shafts can be built with spacing tube diameters equal to the outside diameter of the integral flex element. This is primarily because, for suitably compliant hyperbolic geometries, the fiber angle exiting the diaphragm is typically 42-48 degrees. However, the exit angle may be in the range of approximately 35 degrees to approximately 65 degrees. In the paradigm shift that is an integral all-composite flexible shaft it makes no sense to reduce the diameter of the spacing tube because tube wall thickness would have to increase as the fiber angle also increased and shear strength reduced. While this trade-off is at zero weight change, tooling would be adversely affected, as would torsional buckling performance at reduced tube diameters. With (0/90) carbon content in the tube dedicated to achieving torsional stability and tuning natural frequencies, the S2-glass fiber (+/−45) obviously allows for increased torsional wind-up in long shafts. While the lower modulus is desirable in the compliant, integral flex elements the spacing tube serendipitously compensates via the larger than traditional tube diameter.

An ANSYS parametric FEA file was written allowing for variable hyperbolic geometry including length, inside diameter, outside diameter, outer composite thickness and boundary conditions. The metallic flange attachments were represented by springs and PLANE25 harmonic asymmetric elements were used to keep the run time low while still allowing fully orthotropic material properties and non-axisymmetric loads (bending). Meshing strategy maintained 10 elements through the thickness and acceptable aspect ratios regardless of hyperbolic geometry. Prior analytic models accurately provided for membrane fiber direction stresses so the primary objective of the numerical model was to quantify diaphragm bending stresses and determine the critical locations. The fiber crossing angle changes rapidly with radial position, as does the developed composite thickness. Because composite shell elements were not deemed suitable for our present purpose, only the element I_J side was practical for a material coordinate system. All nine independent stiffness terms were mapped as a function of θ (theta) and curve fitted with the resulting expressions used to generate 78 discrete material property cards.

Three sequential load steps were used to apply 10,000 inch pound torque; 100 lb axial compression; and 100 inch pound bending. By interrogating the as-calculated solution, meridional (I_Jside) stresses were plotted as well as hoop (circumferential) and in-plane shear stresses due to torque.

After completion of the axis-symmetric sensitivity study the model was further developed to produce a full 3-D mesh suitable for extracting eigenvalue buckling solutions under applied torque. In this fashion the design space possible between thin, unstable diaphragms and those too thick to sustain required bending motions was sought out.

Two different hyperbolic geometries are presented graphically to show significant findings. While all results presented use a 6-inch outside diameter the inside diameter was varied from 3.75-inch to 4.9-inch and outer thickness varied from 0.018 inch to 0.03-inch. However, given that the outside diameter can range from approximately 4.0 inches to approximately 24.0 inches, the inside diameter may range from approximately 2.0 inches to approximately 22 inches, the outer thickness may vary from approximately 0.018 inch to approximately 0.08 inch, and the length may range from approximately 6 inches to approximately 180 inches. All meridional stress maximums occurred in the middle of the diaphragm whether caused by axial or bending loads. Conversely, all hoop stress maximums occurred at the outer extremity as did in-plane shear stress due to applied torque. This is true regardless of hyperbolic geometry although peak values may vary.

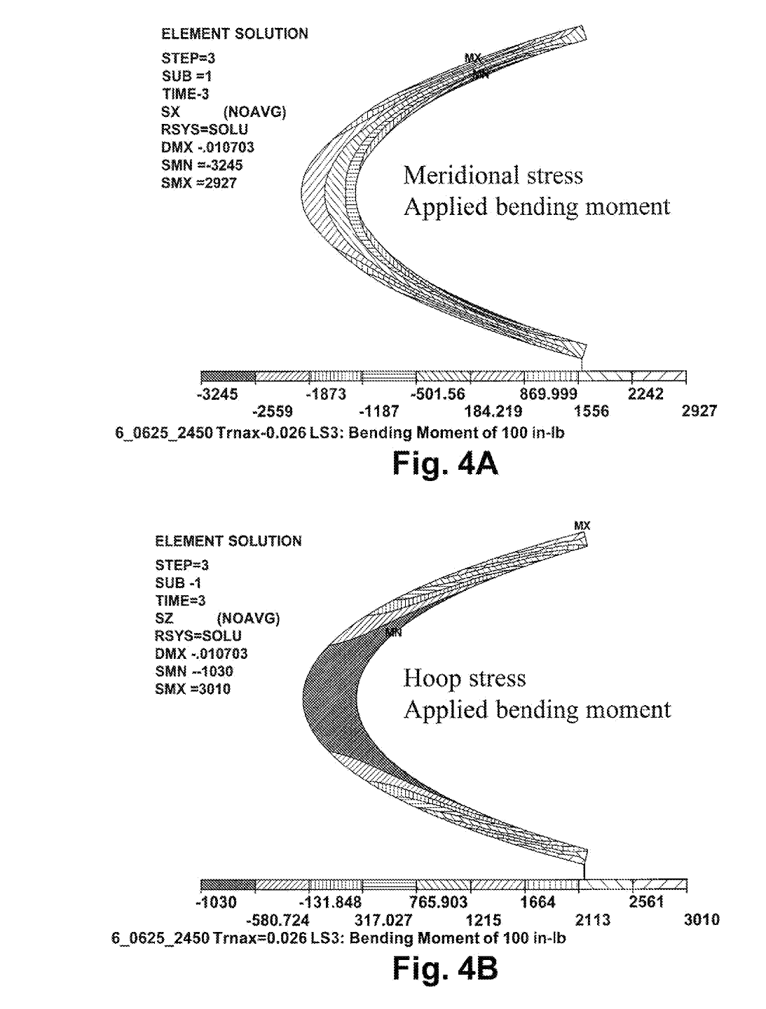

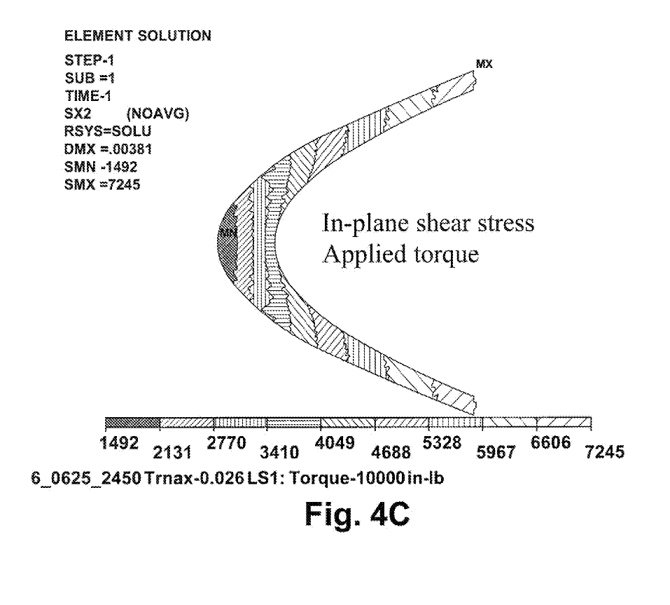

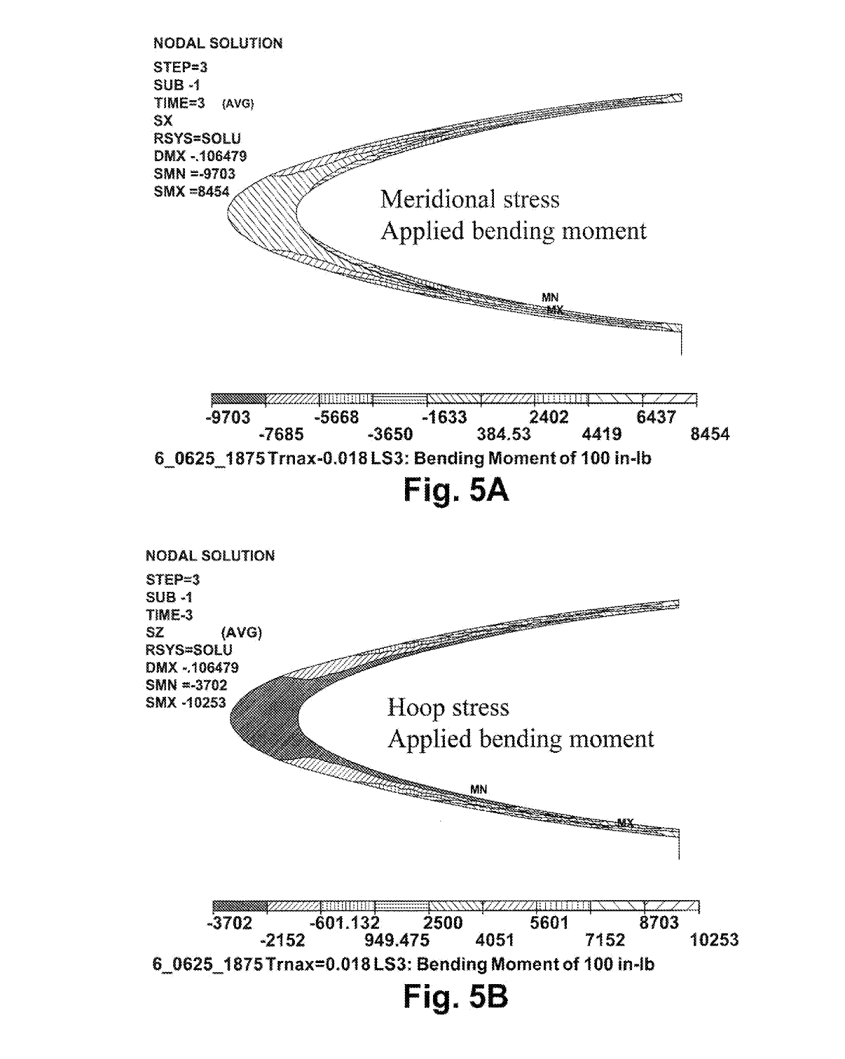

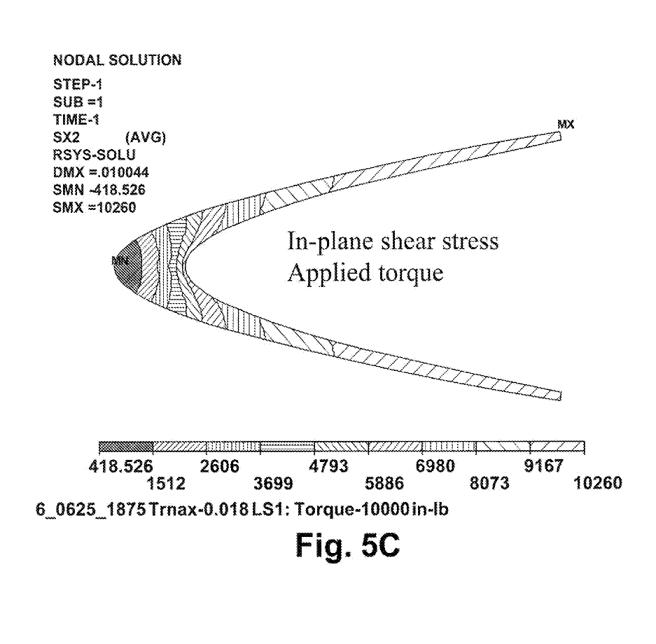

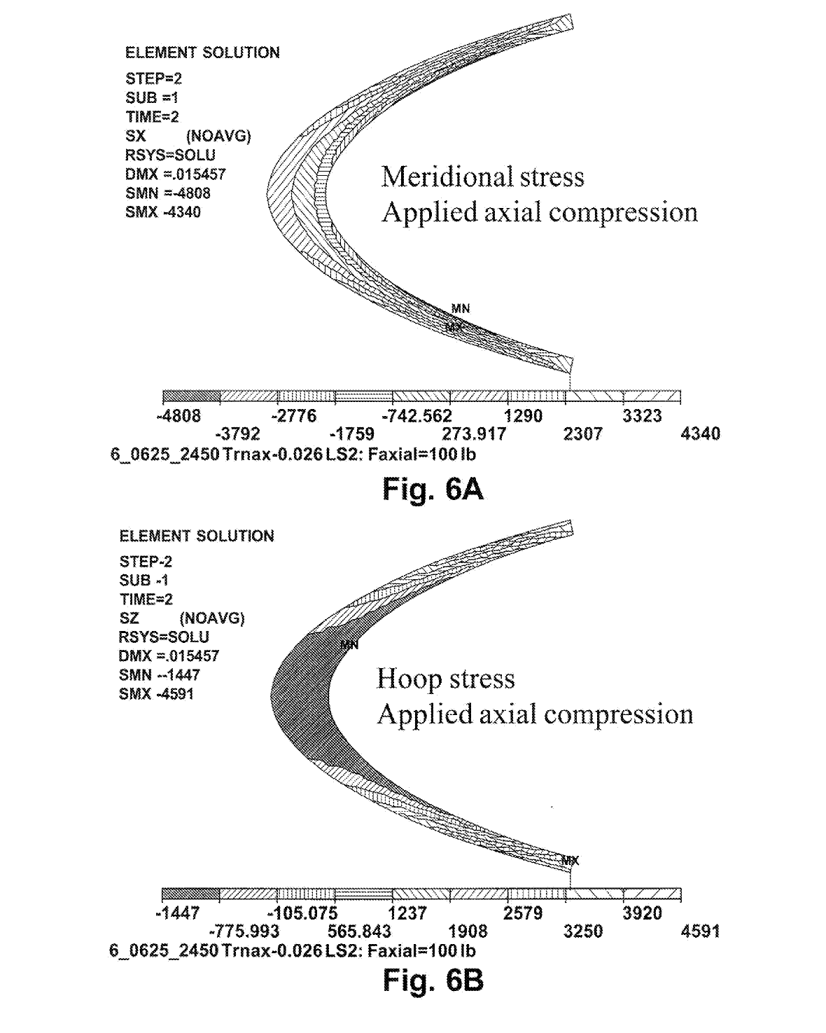

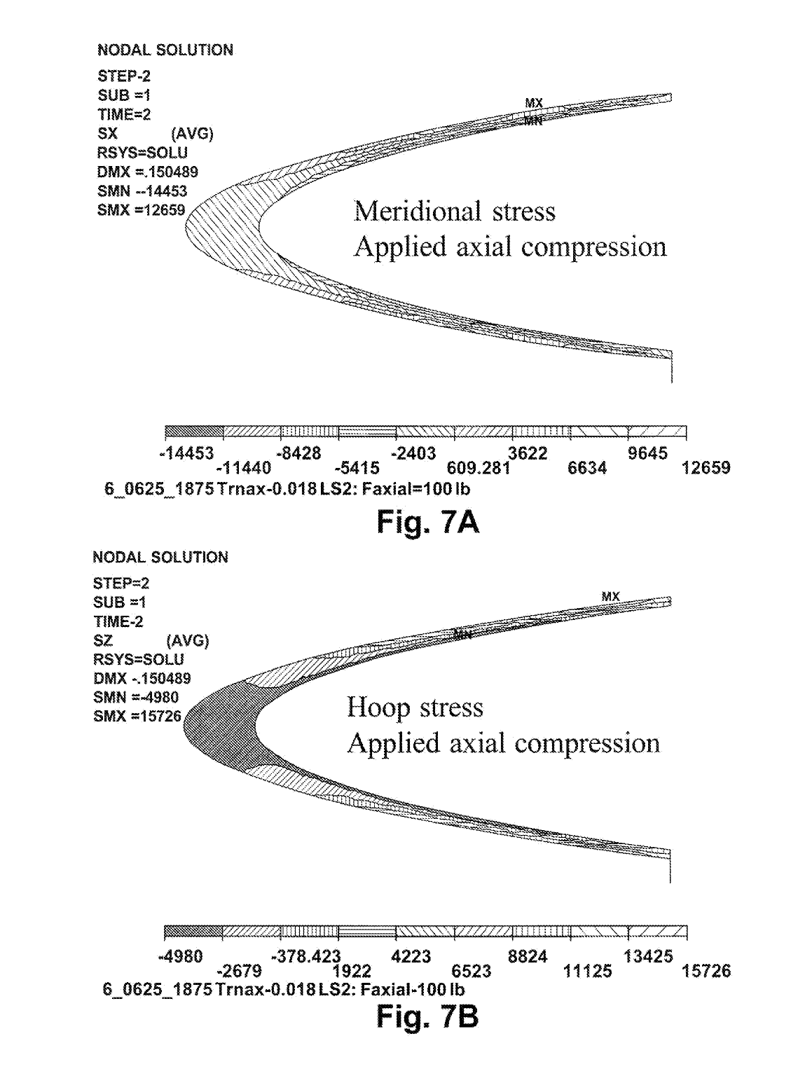

There is different thickness distribution developed by the deeper cross-section with small outer thickness versus the shallower profile with larger outer thickness. In the latter case the torque capacity is substantially higher and the developed bending stresses much lower. Regardless of the technology used, the flexible composite driveshafts of the disclosure sustain essentially steady state stresses due to both applied torque and imposed axial motion but high frequency cyclic loading due to imposed angular misalignment. For this reason the magnitude of bending stresses are of particular interest. The bending stiffness of the shallower diaphragm pair in FIG. 4A-4C is 993 inch pound/deg while the deeper diaphragm of FIGS. 5A-5C is less than 250 inch pounds/deg. So while the skinnier profile sustains three times the meridional stress of the thicker profile under 100 inch pounds bending moment the actual applied bending moment will only be one quarter because structural deflections are applied in service rather than bending moments. Review of axial loading in FIGS. 6A-6B and 7A-7B clearly demonstrate the benefits of installed axial tension to offset both peek hoop and meridionol stresses sustained under angular misalignment. While the skinnier geometry of FIGS. 5A-5C and 7A-7B appears to have a slight advantage in sustaining motion with lower bending stress, there remains the issue of torsional buckling of thinner, deeper diaphragms.

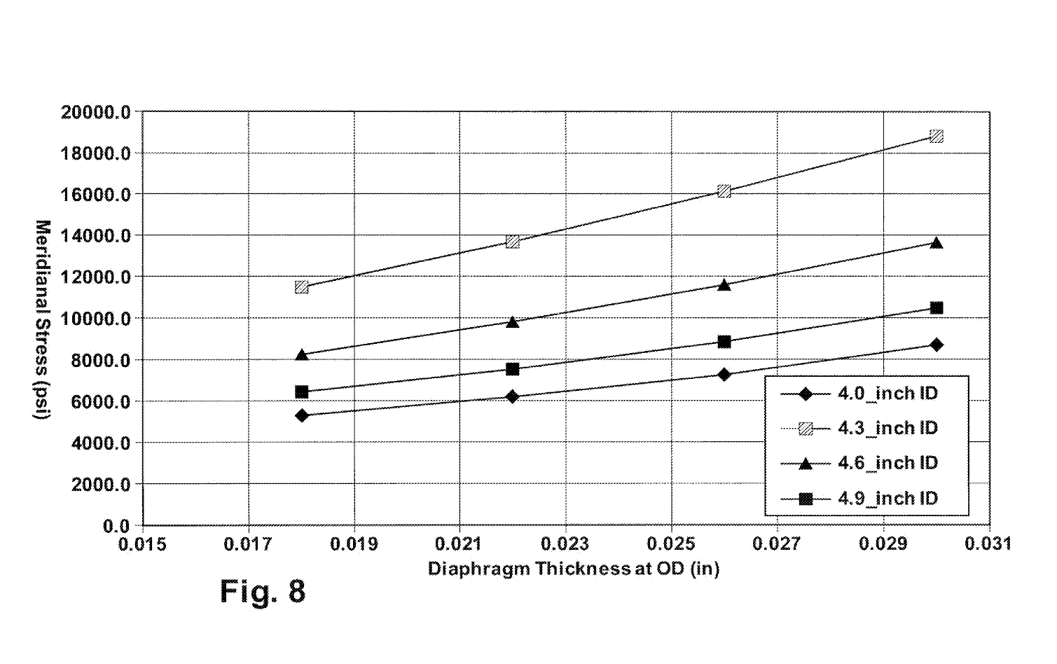

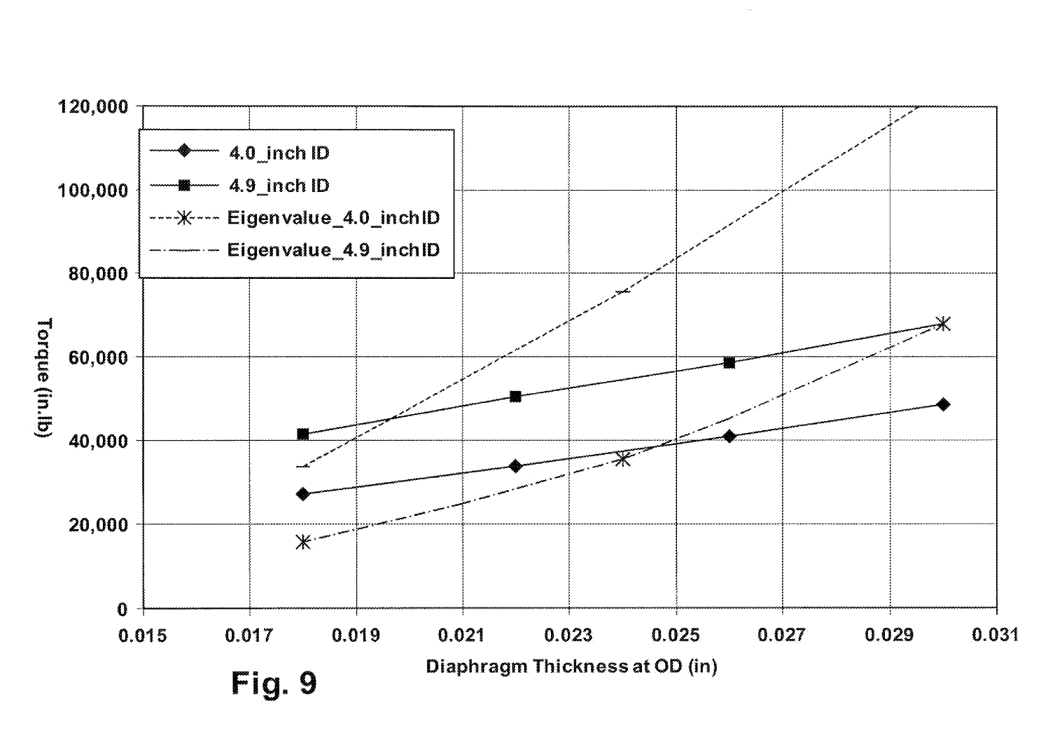

FIG. 8 plots the meridional stress due to diaphragm bending against inside diameter and outer composite thickness. This indicates a much smaller penalty exists for adding thickness to deeper diaphragms than to shallower ones. FIG. 9 plots the torque reaction of the geometries studied following ½-degree of torsional wind-up. Superimposed on these are eigenvalue buckling solutions suggesting minimum outer thickness of 0.025-inch for a 4.0-inch ID and 0.02-inch for a 4.9-inch D.

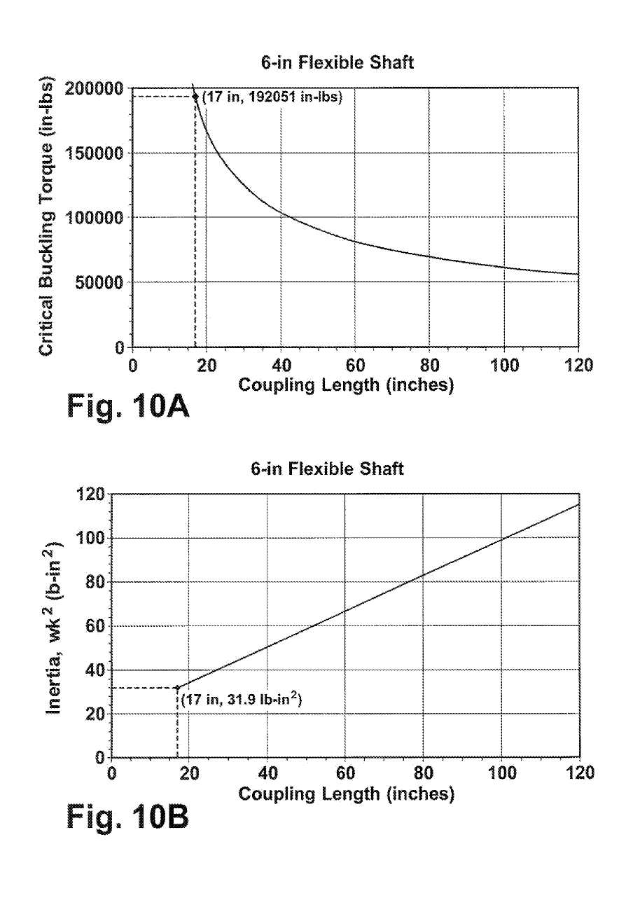

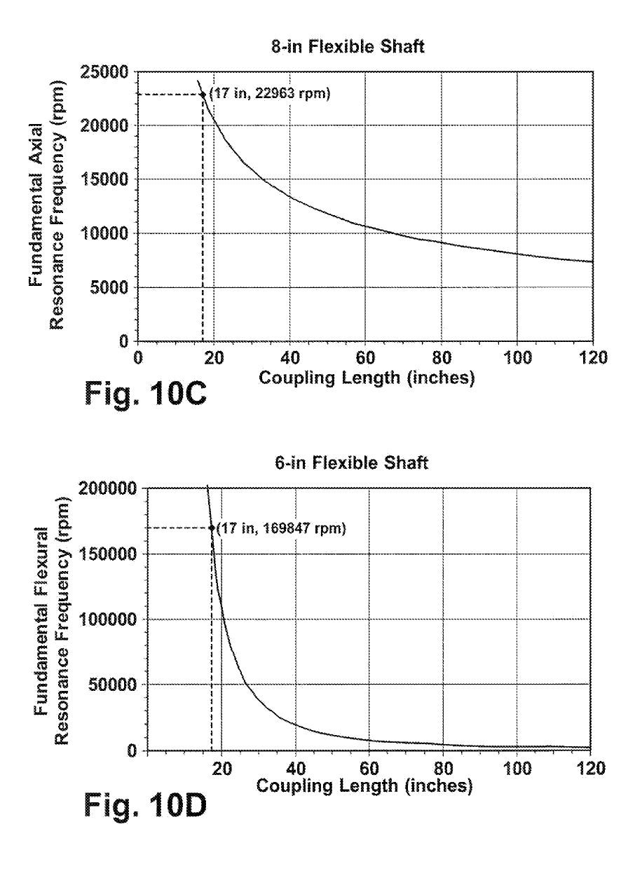

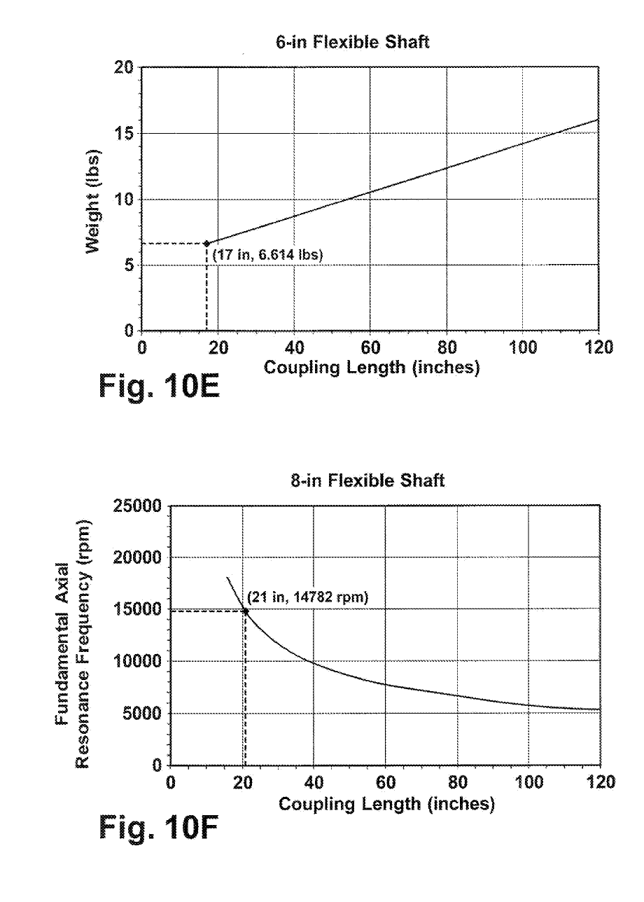

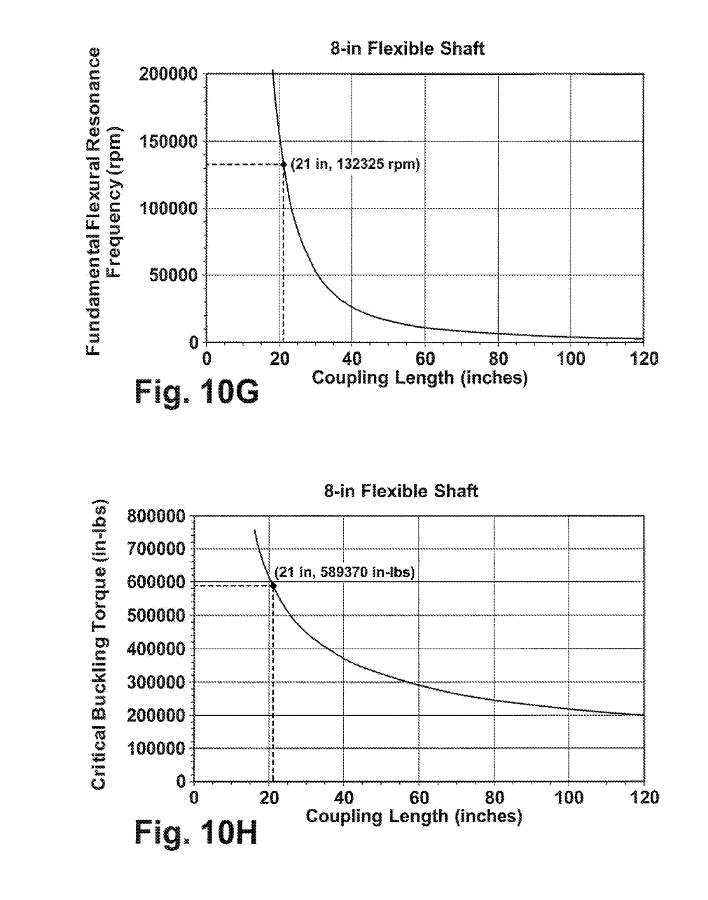

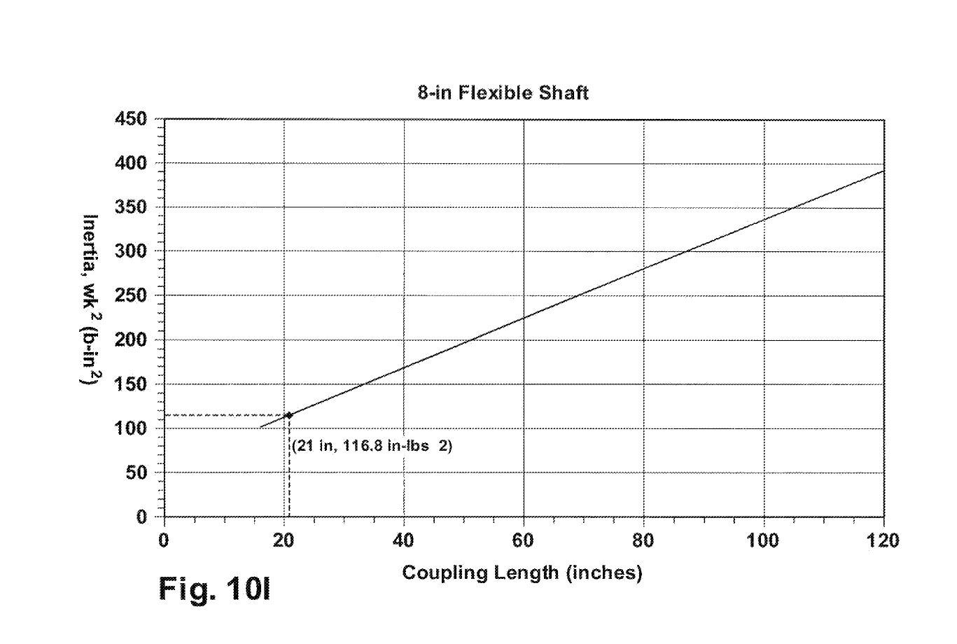

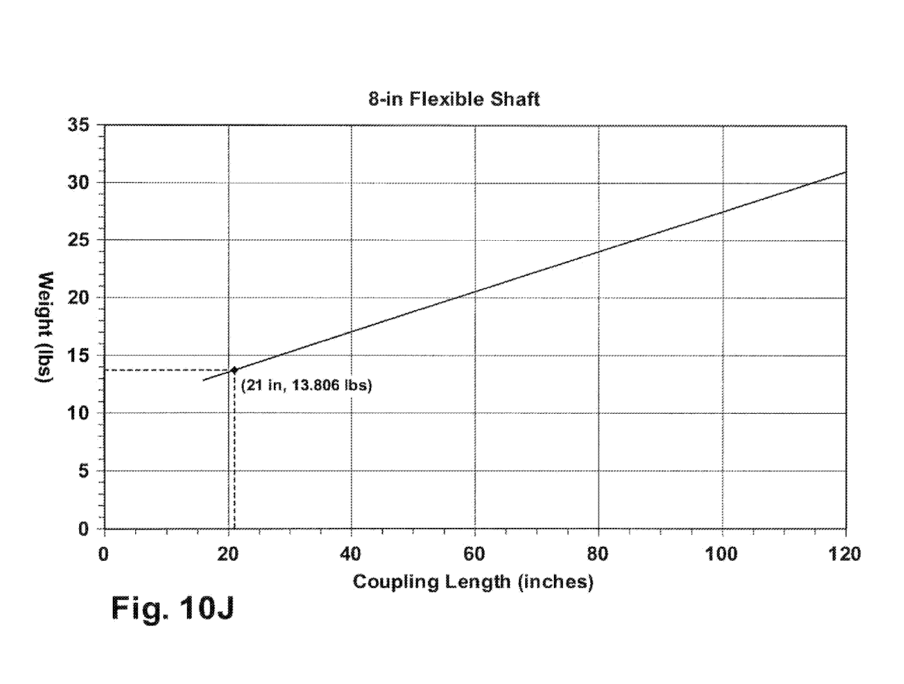

FIGS. 10A-J provides a survey of design parameters for all-composite integral flexible shafts produced in accordance with the disclosure. All-inclusive shaft weights are plotted using steel flanges optimized for infinite fatigue life. These weights are preferably reduced by 2.7 lb per 8 inch shaft and 1.6 lb per 6 inch shaft when using titanium. Fundamental flexural resonance is calculated using spacing tubes which comprise 90 degree (hoop) carbon fiber both inside and outside of the +/−45 degree continuous S2-glass. In the event that higher sub-critical speeds are required then some fraction of the 0.04-inch thick (total) carbon hoop material may be replaced by 0 degree plies. In this way longitudinal modulus increases without a change in shaft weight being incurred. FIGS. 10A-10J provide design parameters for exemplary embodiments having either a 6-inch outer diameter or an 8-inch outer diameter. However, given the broad range of outer diameters that may exist (approximately 4.0 inches to approximately 24 inches), the design parameters may vary as follows: the critical buckling torque may be in the range of approximately 5,500 inch pounds to approximately 2,000,000 inch pounds; the inertia may be in the range of approximately 100 rpm to approximately 100,000 rpm; the fundamental flexural resonance frequency may be in the range of approximately 100 rpm to approximately 100,000 rpm; and the weight of the driveshaft may be in the range of 4.0 lbs. to approximately 200 lbs.

A design and manufacturing process and resulting products are disclosed in which all-composite, fully flexible driveshafts are designed and produced to take advantage of both part count reduction, and overall weight savings approaching 50% when compared with assembled titanium flex elements and carbon fiber spacing tubes.

A manufacturing process is also disclosed that provides for precise and repeatable CNC control and which uses the perfect geodesic path to maximize torque density. Under imposed axial and bending motions a design space has been identified that minimizes diaphragm bending stresses using hyperbolic geometry just thick enough to avoid torsional buckling of the diaphragm. Increased torque and bending motions are achieved when shafts are installed with axial pre-tension, and operational compression is avoided.

What is claimed is:

1. A composite material flexible driveshaft comprising:
an integral composite spacing tube having first and second ends;
a first coupling element formed at the first end of the integral composite tube and a second coupling element formed at the second end of the integral composite tube, each coupling element having at least one pair of diaphragms, each diaphragm having a sculpted profile which extends from an outer diameter to an inner diameter, the sculpted profile formed by a first angled wall which extends from the outer diameter generally defined by a diameter of the integral composite tube to the inner diameter of the diaphragm, an inner diameter wall located at the inner diameter of the diaphragm and contiguous with the first angled wall, and a second angled wall which extends from an opposite side of the inner diameter wall and to the outer diameter, and a shaft attachment structure which extends from the diaphragm and is configured for attachment to a drive element;
the spacing tube and first and second coupling elements being formed by continuous filament wound in a perfect geodesic path.

2. The composite material flexible driveshaft of claim 1, wherein the inside diameter of the first and second coupling elements is in the range of approximately 2.0 inches to approximately 22.0 inches.

3. The composite material flexible driveshaft of claim 1, wherein the outer thickness of the first and second coupling elements is in the range of approximately 0.018 inches to approximately 0.08 inches.

4. The composite material flexible driveshaft of claim 1, wherein the outside diameter of the first and second coupling elements is in the range of approximately 4.0 inches to approximately 24.0 inches and the length of the first and second coupling elements is in the range of approximately 6 inches to approximately 180 inches.

5. The composite material flexible driveshaft of claim 1, wherein the critical buckling torque is in the range of approximately 5,500 inch pounds to approximately 2,000,000 inch pounds.

6. The composite material flexible driveshaft of claim 1, wherein the inertia is in the range of approximately 5 lb-in² to approximately 10,000 lb-in².

7. The composite material flexible driveshaft of claim 1, wherein the fundamental axial resonance frequency is in the range of approximately 100 rpm to approximately 100,000 rpm.

8. The composite material flexible driveshaft of claim 1, wherein the fundamental flexural resonance frequency is in the range of approximately 100 rpm to approximately 100,000 rpm.

9. A composite material flexible driveshaft of claim 1, wherein the weight of the driveshaft is in the range of approximately 4.0 lbs. to approximately 200 lbs.

10. A composite material flexible driveshaft comprising:
an integral composite spacing tube having a first end and a second end;
a first coupling element attached to the first end of the integral composite tube and a second coupling element attached to the second end of the integral composite tube, each coupling element having at least one pair of deeply sculpted diaphragms that are comprised of single continuously anisotropic shell of fibers wound in a perfect geodesic path, each at least one pair of deeply sculpted diaphragms having constantly varying thickness and constantly varying material properties;
a first shaft attachment which is mechanically connected at one end to the at least one pair of deeply sculpted diaphragms of the first coupling element and mechanically connected at the other end to a first drive element; and
a second shaft attachment which is mechanically connected at one end to the at least one pair of deeply sculpted diaphragms of the second coupling element and mechanically connected at the other end to a second drive element.

11. The composite material flexible driveshaft of claim 10 wherein the fiber angle exiting each of the at least one pair of deeply sculpted diaphragms is approximately 35 to approximately 65 degrees.

12. The composite material flexible driveshaft of claim 10, wherein the inside diameter of the first and second coupling elements is in the range of approximately 2.0 inches to approximately 22.0 inches.

13. The composite material flexible driveshaft of claim 10, wherein the outer thickness of the first and second coupling elements is in the range of approximately 0.018 inches to approximately 0.08 inches.

14. The composite material flexible driveshaft of claim 10, wherein the outside diameter of the first and second coupling elements is in the range of approximately 4.0 inches to approximately 24.0 inches and the length of the first and second coupling elements is in the range of approximately 6 inches to approximately 180 inches.

15. The composite material flexible driveshaft of claim 10, wherein the critical buckling torque is in the range of approximately 5,500 inch pounds to approximately 2,000,000 inch pounds.

16. The composite material flexible driveshaft of claim 10, wherein the inertia is in the range of approximately 5 lb-in² to approximately 10,000 lb-in².

17. The composite material flexible driveshaft of claim 10, wherein the fundamental axial resonance frequency is in the range of approximately 100 rpm to approximately 100,000 rpm.

18. The composite material flexible driveshaft of claim 10, wherein the fundamental flexural resonance frequency is in the range of approximately 100 rpm to approximately 100,000 rpm.

19. A composite material flexible driveshaft of claim 10, wherein the weight of the driveshaft is in the range of approximately 4.0 lbs. to approximately 200 lbs.

20. A composite material flexible driveshaft comprising:
an integral composite spacing tube having a first end and a second end;
a first coupling element attached to the first end of the integral composite tube and a second coupling element attached to the second end of the integral composite tube, each coupling element having at least one pair of deeply sculpted diaphragms that are comprised of single continuously anisotropic shell of fibers wound in a perfect geodesic path, each at least one pair of deeply sculpted diaphragms having constantly varying thickness and constantly varying material properties and an exit angle of approximately 35 degrees to approximately 65 degrees;
a first shaft attachment structure which extends from the first coupling element that is configured for attachment to a drive element; and
a second shaft attachment structure which extends from the second coupling element that is configured for attachment to a drive element.
